(19) United States
(12) Patent Application Publication
(10) Pub. No.: US 2009/0003135 A1
(43) Pub. Date: Jan. 1, 2009

(54) System for Localizing and Positioning Towed Acoustic Linear Antennas

(76) Inventors: Gaetan Mellier, Nantes (FR); Gilles Poete, Saffre (FR)

Correspondence Address: PAULY, DEVRIES SMITH & DEFFNER, L.L.C., Plaza VII-Suite 3000, 45 South Seventh Street, MINNEAPOLIS, MN, 55402-1630, US

(21) Appl. No.: 11/849,449

(22) Filed: Sep. 4, 2007

(30) Foreign Application Priority Data
Sep. 4, 2006 (FR) FR 06/07716

(51) Int. Cl. G01S 3/80

(52) U.S. Cl. 367/118

(57) ABSTRACT

A system for localizing and positioning towed acoustic linear antennas. In one aspect, a system for localizing and positioning towed acoustic linear antennas includes two or more linear antennas, where each linear antenna has at least one distance measurement device configured to measure the distance to at least one adjacent linear antenna and to transmit signals corresponding to distance measurements. The system further includes one or more navigational control devices along each linear antenna that are configured to control at least the lateral position of each linear antenna. The system also includes one or more controllers distributed over the length of each linear antenna, where each controller is configured to receive distance measurement signals from at least one distance measurement device, process the distance measurement signals, and to control at least one navigational control device according to the processed distance measurement signals. Other aspects are disclosed.

### RELATED APPLICATIONS

This application claims priority to French Patent Application No. FR 06/07716, filed on Sep. 4, 2006, which is hereby incorporated by reference in its entirety.

### FIELD OF THE INVENTION

The field of the invention is seismic data acquisition. More precisely, the invention relates to equipment for sea floor analysis.

### BACKGROUND OF THE INVENTION

This invention relates to the field of seismic data acquisition. More specifically, it relates to equipment for sea floor analysis. The invention relates in particular to the industry of oil exploration by the seismic method, but can be applied to any field implementing a seismic data acquisition network in a marine environment.

In the field of the invention, the operations for on-site acquisition of geophysical data conventionally use sensor networks (referred to as “hydrophones” when concerning data acquisition in a marine environment). To collect geophysical data in a marine environment, one or more submerged seismic sources is (are) activated in order to propagate omni-directional seismic wave trains. The sources currently implemented to carry out seismic studies are air guns. The wave trains generated are captured by the hydrophones mentioned above, which are distributed along cables to form acoustic linear antennas, commonly referred to as “streamers”.

Conventionally, the acquisition of seismic data in the environment is performed using a series of streamers towed by a watercraft. Each streamer can include a head buoy and a tail buoy that include global satellite positioning systems in order to precisely localize each streamer. This localization of streamers is important, in particular for monitoring the position of the hydrophones in order to obtain a satisfactory precision of the image of the sea floor, detecting the movements of the streamers with respect to one another, and monitoring the navigation of streamers, in particular in a situation of bypassing an obstacle such as an oil barge.

It is noted that streamers are constituted by an assembly of sections generally having a length of around 150 meters each, and the streamers are capable of having a total length of several kilometers (conventionally 6 to 7 kilometers). In practice, it is desirable to perform the analysis of a sea bed with a minimum number of passages of the watercraft over the area concerned. For this, the width of the sensor network is increased as much as possible, which involves implementing a large number of streamers. The problem of localizing streamers is therefore particularly difficult in consideration of their length and number.

Indeed, the streamers are subjected to various external natural constrains of variable magnitude, such as the wind, waves, currents, and so on. These constraints regularly lead to relative movements of the streamers, at the risk of becoming entangled, which can cause more or less substantial damage to the streamers. Currently, a solution to attempt to control the respective positions of the streamers lies in the implementation of navigation control devices (commonly referred to by the aviation term “birds”) such as those described by the patent document published under number FR-2-870 509. These devices include a body equipped with pivoting wings making it possible to laterally modify the position of the streamers. In addition, “birds” can be equipped with pressure sensors in order to detect the variations in depth and bring the streamer to a predetermined depth.

Moreover, the assembly of birds is conventionally controlled by a centralized system such as that described by the patent document published under number WO-02 103393. According to this technique, active controllers (acoustic transducers, GPS devices, etc.) are regularly distributed along streamers and the signals provided by these controllers are transmitted to a master controller present on the research watercraft. The master controller centralizes and processes the data in order to compare it with a predetermined configuration. According to the result of this comparison, the master controller sends instructions to the birds distributed along the streamers in order to modify their positions. This technique, due to the centralized data processing, involves a number of disadvantages, including that multiple data items are processed and require high-performing and therefore expensive processing means (master controller), the data recovery and processing time as well as the instruction routing time can lead to real time delays between the detected position and the real position at the time of the instruction recovery, and if there is a failure of the master controller, it is no longer possible to exert any control on the position of the streamers.

The invention is in particular intended to overcome these disadvantages of the prior art.

### SUMMARY OF THE INVENTION

The invention relates to a system for localizing and positioning towed acoustic linear antennas. In one aspect, a system for localizing and positioning towed acoustic linear antennas includes two or more linear antennas, where each linear antenna has at least one distance measurement device configured to measure the distance to at least one adjacent linear antenna and to transmit signals corresponding to distance measurements. The system further includes one or more navigational control devices along each linear antenna that are configured to control at least the lateral position of each linear antenna. The system also includes one or more controllers distributed over the length of each linear antenna, where each controller is configured to receive distance measurement signals from at least one distance measurement device, process the distance measurement signals, and to control at least one navigational control device according to the processed distance measurement signals.

The invention may be more completely understood by considering the detailed description of various embodiments of the invention that follows in connection with the accompanying drawings.

### BRIEF DESCRIPTION OF THE DRAWINGS

FIG. 1 is a diagram showing a network of streamers in a straight line configuration.

FIG. 2 is a diagram showing a network of streamers in a curved configuration.

While the invention may be modified in many ways, specifics have been shown by way of example in the drawings and will be described in detail. It should be understood, however, that the intention is not to limit the invention to the particular embodiments described. On the contrary, the intention is to cover all modifications, equivalents, and alternatives following within the scope and spirit of the invention as defined by the claims.

### DETAILED DESCRIPTION OF THE INVENTION

The invention is intended to propose a technique for localizing and positioning streamers, which is more effective than the techniques known from the prior art. In this sense, the invention is in particular intended to provide such a technique that is notably more reactive between the detection of a streamer position and the actual execution of a streamer positioning instruction. The invention is also intended to provide such a technique that involves the implementation of data processing means that are less complex and/or less expensive than those of the prior art. The invention is also intended to provide such a technique that makes it possible to track the positioning of certain streamers in the event of a local failure of the system.

The objectives, as well as others, which will appear below, are achieved by the invention, which relates to a system for localizing and positioning towed acoustic linear antennas, which linear antennas each have distance measurement devices for measuring the distance of at least one adjacent linear antenna, and navigation control devices distributed over the length of the linear antennas and being able to act at least laterally on the position of the linear antennas. The system also includes a controller distributed over each linear antenna and configured for controlling each navigation control device. The controller is intended to communicate locally with the distance measurement devices in order to collect and process data provided by the distance measurement devices and to control, according to this data, the navigation control devices.

Thus, with the invention, it is possible to obtain a system for localizing and positioning towed linear antennas (streamers) that is notably more reactive than the techniques of the prior art. Indeed, the distribution of the controllers along the streamers makes it possible to place these controllers directly in the vicinity of the distance measuring devices and the navigation control devices. Thus, the time for routing data between the distance measuring devices and the controllers is considerably limited, as is the time for routing instructions between the controllers and the distance measuring devices. In other words, the detected position of a streamer is the same as that of the streamer when the instruction sent to the navigation control device is executed, which ensures reliable positioning of the streamers.

In addition, the processing of data is ensured by a plurality of controllers distributed along the streamers makes it possible to avoid the use of burdensome and expensive centralized processing devices on the towing watercraft and to continue controlling certain streamers even in the event of a failure of one or more of the controllers.

According to a preferred solution, the distance measuring devices use an acoustic measuring system, wherein the acoustic measurement is preferably bidirectional. According to a preferred embodiment, the distance measuring devices include a plurality of acoustic signal transducers, which acoustic transducers are preferably designed to transmit and receive acoustic signals. In this way, the number of components present along the streamers is limited, and with relatively inexpensive technology.

According to an advantageous feature, the linear antennas each include a plurality of sections of which some are connected to one another by connection elements that include the controllers. In this case, the connection elements may also include the navigation control devices. It is noted that the density of the controllers in the streamer network is preferably the same as that of the connection elements.

The system advantageously includes depth measurement devices for measuring the depth of various points of the linear antennas and controllers for processing data provided by the depth measuring means in order to project the data provided by the distance measuring devices in a substantially horizontal plane. In this case, the depth measuring devices are advantageously integrated with the connection elements. According to another feature, the system includes a means for synchronizing the distance measuring means. In addition, the system includes bearing measuring devices in order to optimize the localization and positioning of the set of streamers.

As indicated above, the principle of the invention lies in the fact of distributing, in the streamer network, the processing of data provided by the distance measuring devices, in order to correct the positions of the streamers by way of the navigation control devices. In the following description, the term “streamer” is used to designate a towed acoustic linear antenna.

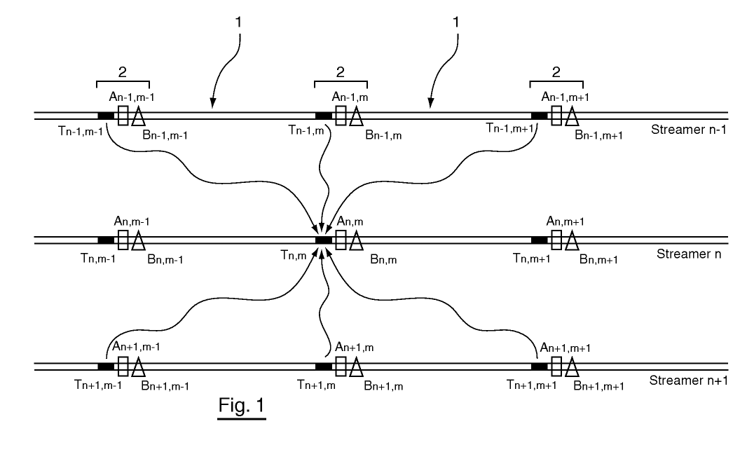

FIG. 1 shows a network of streamers in a configuration in which they navigate parallel with respect to one another in a straight line. Each streamer includes, in a regularly distributed manner (for example every 300 meters (or every 2 sections)) distance measuring devices T and navigation control devices B, with the navigation control devices being “birds” according to this embodiment, such as, for example, those described by the patent document published under number FR-2 870 509. The distance measuring devices use an acoustic measuring system. This acoustic measurement is bidirectional.

According to this embodiment, the distance measuring devices are acoustic transducers that communicate with one another so that the transducers Tn−1, m−1; Tn−1, m; Tn−1, m+1 of a streamer n−1 and the transducers Tn+1, m−1; Tn+1, m; Tn+1, m+1 of a streamer n+1 each transmit a signal at different times in the time received by the transducer Tn, m of a streamer n. For this, each transducer includes capabilities for transmitting and capabilities for receiving an acoustic signal. The measurement of the distance between the equipment is performed by any acoustic measuring device known to a person skilled in the art. The measurement of the detector positions with respect to one another is thus performed closer and closer, in a synchronized manner, over the entire streamer network.

It is noted that the system can involve the designation of a reference streamer with respect to which the other streamers are repositioned at regular intervals. In addition, in the case of a synchronization of the various components of the system, this synchronization can be ensured by a controller on board the towing watercraft. More specifically, a synchronization order is sent to all of the transducers T, which order can consist of a transmission order, a receiving order or an inactivity order. The distance measurements are performed for the transducers concerned, with the corresponding data being stored by the transducers that have received a receiving order. The cycle is repeated with other transducers until all of the transducer positions have been mapped.

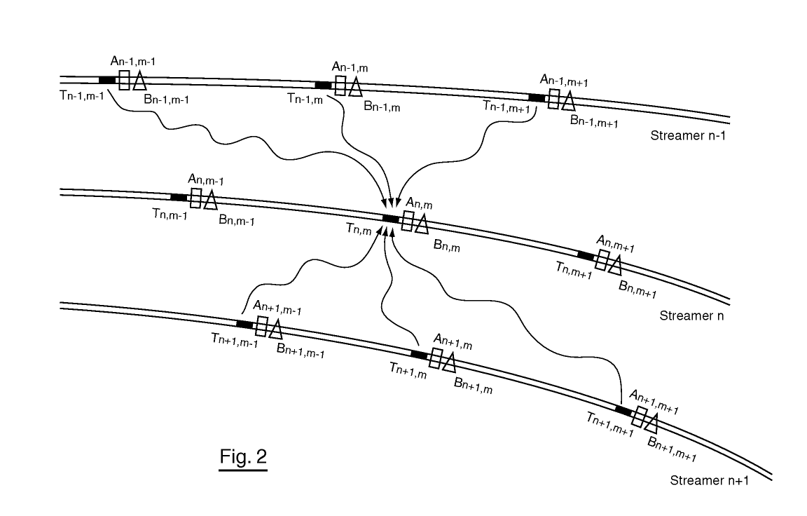

According to the principle of the invention, each streamer also has controllers A distributed over the length of the streamer and placed in the vicinity of a “bird” so that the controllers An, m−1; An, m; An, m+1 of a streamer n communicate locally, respectively, with the “birds” Bn, n−1; Bn, m; Bn, m+1 of the same streamer, after processing the data transmitted by the network of neighboring transducers. It is understood that, according to the invention, the transducers T communicate with one another so as to determine the respective positions, then transmit the data concerning their position to the controllers A locally corresponding to them (An, m+1 for the transducer Tn, m+1; An, m for Tn, m; etc.), with the latter transmitting an instruction to the corresponding bird (Bn, m+1 for the feedback control means An, m+1; Bn, m for An, m; etc.). In this way, the streamers can be kept at the desired distance from one another, with the controllers A being configured so as to maintain this distance in a straight line configuration as shown in FIG. 1 as well as in a curved configuration as shown in FIG. 2. In practice, it is desirable to maintain a spacing of around 25 meters between the streamers.

It is noted that the streamers are constituted by the assembly of sections 1, some of which sections are connected to one another by connection elements 2. According to a preferred solution, each connection element includes an on-board electronic system including controllers A, and has a bird B. In addition, the transducers T are mounted on the neighboring sections of each connection element (which can very similarly be integrated directly in the connection elements according to a possible alternative).

According to an embodiment, the connection elements include pressure sensors so as to measure the depth of the streamer in the location of the bird considered. The data corresponding to the depth is transmitted to processors on the streamers, which processors make it possible, with a suitable algorithm, to carry out a projection of the transducer position in a horizontal plane. According to an embodiment, these processors corresponding to the depth are integrated in the on-board electronic system of the connection elements.

In addition, the connection elements each have (or only some of them have) a compass enabling bearing data to be obtained. This data, combined with that on the transducer positions, can make it possible to optimize the repositioning of the streamers by detecting the configuration of the streamers with respect to one another (in a straight or curved line).

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

The above specification provides a complete description of the structure and use of the invention. Since many of the embodiments of the invention can be made without parting from the spirit and scope of the invention, the invention resides in the claims.

What is claimed is:

1. A system for localizing and positioning towed acoustic linear antennas, the system comprising:
(i) two or more linear antennas, each linear antenna having at least one distance measurement device configured to measure the distance to at least one adjacent linear antenna and to transmit signals corresponding to distance measurements;
(ii) one or more navigational control devices along each linear antenna and configured to control at least the lateral position of each linear antenna;
(iii) one or more controllers distributed over the length of each linear antenna, each controller being configured to receive distance measurement signals from at least one distance measurement device, process the distance measurement signals, and to control at least one navigational control device according to the processed distance measurement signals.

2. The system for localizing and positioning towed acoustic linear antennas of claim 1, where the distance measurement devices use an acoustic measuring system to measure distance to an adjacent linear antenna.

3. The system for localizing and positioning towed acoustic linear antennas of claim 2, where the acoustic measurement is bidirectional.

4. The system for localizing and positioning towed acoustic linear antennas of claim 2, where the distance measuring devices are designed to transmit and receive acoustic signals.

5. The system for localizing and positioning towed acoustic linear antennas of claim 1, where each linear antenna includes a plurality of sections and connection elements for connecting the plurality of sections, where the controllers are located on the connection elements.

6. The system for localizing and positioning towed acoustic linear antennas of claim 5, where the one or more navigational control devices are located on the connection elements.

7. The system for localizing and positioning towed acoustic linear antennas of claim 1, further comprising at least one depth measurement device configured to measure the depth of various points of the linear antennas, and where the controllers are configured to process data from the depth measurement devices and distance measurement devices in order to project the distance measurements in a substantially horizontal plane.

8. The system for localizing and positioning towed acoustic linear antennas of claim 7, where the depth measurement devices are located on the connection elements.

9. The system for localizing and positioning towed acoustic linear antennas of claim 5, where the connection elements include a bearing data acquisition device.

10. The system for localizing and positioning towed acoustic linear antennas of claim 1, further configured to synchronize the distance measurement devices.

11. A system for localising and positioning towed acoustic linear antennas, which linear antennas each have means for measuring the distance (T) of at least one adjacent linear antenna, with navigation control means (B) distributed over the length of said linear antennas being associated with each linear antenna in order to act at least laterally on the position of said linear antennas,
characterised in that it includes, for each linear antenna, means for feedback control (A) of said control means (B) distributed over the length of said linear antennas and intended to communicate locally with said distance measuring means in order to collect and process data provided by said distance measuring means (T) and to control, according to said data, said control means (B).
